(19) United States
(12) Patent Application Publication
(10) Pub. No.: US 2006/0294365 A1
(43) Pub. Date: Dec. 28, 2006

(54) Mail server authentication method and apparatus

(75) Inventor: Sung-hoon Bae, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/472,298

(22) Filed: Jun. 22, 2006

(30) Foreign Application Priority Data
Jun. 23, 2005 (KR) 10-2005-0054374

(51) Int. Cl. H04L 9/00

(52) U.S. Cl. 713/155

(57) ABSTRACT

A mail server authentication method and apparatus are provided, which can be performed in a mail client controlling transmission of an e-mail to a mail server, in which the transmission of the e-mail is requested with which authentication information is provided, whether the mail server authenticates the request is determined using an authentication method represented in the provided authentication information, if a determination is made that the mail server does not authenticate using the represented authentication method, an authentication method is searched for, which can be performed by the mail server, and a result obtained by the mail server is received, which authenticates the request using the searched authentication method. Accordingly, advance knowledge as to whether the mail server performs authentication and what kind of authentication method is used is not required.

### CROSS-REFERENCE TO RELATED PATENT APPLICATION

This application claims the benefit under 35 U.S.C. § 119(a) of Korean Patent Application No. 10-2005-0054374, filed on Jun. 23, 2005, in the Korean Intellectual Property Office, the entire disclosure of which is hereby incorporated by reference.

### BACKGROUND OF THE INVENTION

1. Field of the Invention

The present invention relates to mail server authentication. More particularly, the present invention relates to a mail server authentication method and apparatus, where if a mail server does not specify an authentication method by which to send an e-mail, in authentication information provided with the e-mail, a mail client automatically searches for an authentication method supported by the mail server and requests the mail server to perform authentication according to the authentication method determined.

2. Description of the Related Art

A user can create an e-mail using a mail processing program in a personal computer (PC). A Microsoft program called Outlook Express, for example, is one such mail processing program.

An e-mail can be created using a PC, and recently, a multi function peripheral (MFP) having a scan function may create an e-mail using scanned data as text.

An e-mail can also be created using various methods. A mail client transmits the created e-mail to a mail server using a simple mail transfer protocol (SMTP). Here, if an authentication process is required between the mail client and the mail server, the mail client can transmit the e-mail to the mail server if the mail server determines that the transmission is possible using the authentication process.

If a created e-mail and information regarding an authentication method input by a user are provided to the mail client, the mail client can transmit the e-mail to the mail server if a result determined by the mail server using the input authentication method has contents determining that the e-mail can be transmitted.

In creating an e-mail, a user does not usually think about whether the authentication process is required or what kind of authentication method is required.

For example, if information regarding an authentication method is input to the mail client, regardless of the fact that the mail server does not require authentication, a relevant e-mail cannot be transmitted to the mail server.

Thus, in a conventional mail server authentication apparatus, an e-mail cannot be transmitted if a mail server does not specify an authentication method for transmitting the e-mail contained in authentication information provided with the e-mail.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a mail server authentication method, by which if a mail server does not specify an authentication method for sending an e-mail, in authentication information provided with the e-mail, a mail client automatically searches for an authentication method supported by the mail server and requests the mail server to perform authentication according to a determined authentication method.

The present invention also provides a mail server authentication apparatus, by which if a mail server does not specify an authentication method for sending an e-mail, in authentication information provided with the e-mail, a mail client automatically searches for an authentication method supported by the mail server and requests the mail server to perform authentication according to the determined authentication method.

The present invention also provides a computer readable recording medium storing a computer readable program, by which if a mail server does not specify an authentication method for sending an e-mail, in authentication information provided with the e-mail, a mail client automatically searches for an authentication method supported by the mail server and requests the mail server to perform authentication according to the determined authentication method.

According to an aspect of exemplary embodiments of the present invention, there is provided a mail server authentication method, which can be performed in a mail client controlling transmission of an e-mail to a mail server, in which the transmission of the e-mail is requested, with which authentication information is provided; whether the mail server authenticates the request using an authentication method represented in the provided authentication information is determined; if a determination is made that the mail server does not authenticate using the represented authentication method, an authentication method is searched for, which can be performed by the mail server; and a result obtained by the mail server is received, which authenticates the request using the searched authentication method.

In an exemplary implementation, if a determination is made that the mail server does not authenticate using the represented authentication method, informing that the transmission cannot be performed.

In another exemplary implementation, whether the transmission is possible is determined from the authentication; and if a determination is made that the transmission is possible, the transmission is performed.

In still another exemplary implementation, if a determination is made that the transmission is impossible, informing that the transmission cannot be performed. Also, if a determination is made that the transmission is possible, informing that the transmission is possible.

In a further exemplary implementation, the mail server is selected from among more than one mail server.

In an exemplary implementation, whether the mail server and the mail client are connected by a network is determined; and the requesting is proceeded to, if a determination is made that the mail server and the mail client are connected by a network.

In another exemplary implementation, an authentication method, which can be performed by the mail server, is searched again, and the requesting or the receiving is proceeded to.

In still another exemplary implementation, a re-searched authentication method is informed. Also, the searched authentication method is displayed; and authentication information representing the searched authentication method is generated for replacing the provided authentication information and the requesting is proceeded to.

In a further exemplary implementation, if a determination is made that the authentication is performed using the represented authentication method, a result obtained by the mail server is received, which authenticates the request using the represented authentication method.

In an exemplary implementation, at least one of the provided authentication information and the searched authentication information are stored. The authentication information may comprise information regarding an authentication target.

According to another aspect of exemplary embodiments of the present invention, there is provided a mail server authentication apparatus controlling an e-mail to be transmitted to a mail server, in which a transmission request unit requests the transmission of the e-mail, with which authentication information is provided; a controller examines whether the mail server authenticates the request using an authentication method represented in the provided authentication information and the authentication result corresponding to a control signal is received; an authentication method search unit searches for an authentication method, which can be performed by the mail server in response to the examination result and the search result is output as the control signal.

In an exemplary implementation, a user interface unit informs that the transmission cannot be performed in response to the examination result. Also, a user interface unit informs of the search result.

In another exemplary implementation, a mail transmitter performs the transmission corresponding to a transmission command signal, wherein the controller examines whether the transmission is possible through the authentication and outputs the examination result as the transmission command signal.

In still another exemplary implementation, a user interface unit informs whether the transmission can be performed corresponding to the transmission command signal. The authentication method search unit searches again for an authentication method, which can be performed in the mail server corresponding to the transmission command signal.

In a further exemplary implementation, a user interface unit informs of a re-searched authentication method. Also, a user interface unit through which the mail server is selected from among more than one mail server is included.

According to another aspect of exemplary embodiments of the present invention, there is provided a computer readable recording medium storing a computer readable program for performing a mail server authentication method, which can be performed in a mail client controlling an e-mail to be transmitted to a mail server, in which the transmission of the e-mail is requested, with which authentication information is provided; whether the mail server authenticates the request using an authentication method represented in the provided authentication information is determined; if a determination is made that the mail server does not authenticate using the represented authentication method, an authentication method which can be performed by the mail server is searched for; and a result obtained by the mail server is received, which authenticates the request using the searched authentication method.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a block diagram of a mail server authentication apparatus according to an exemplary embodiment of the present invention;

FIG. 2 is an example of contents displayed on a user interface unit illustrated in FIG. 1;

FIG. 3 is another example of contents displayed on a user interface unit illustrated in FIG. 1; and

FIGS. 4A and 4B are flowcharts illustrating a mail server authentication method according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

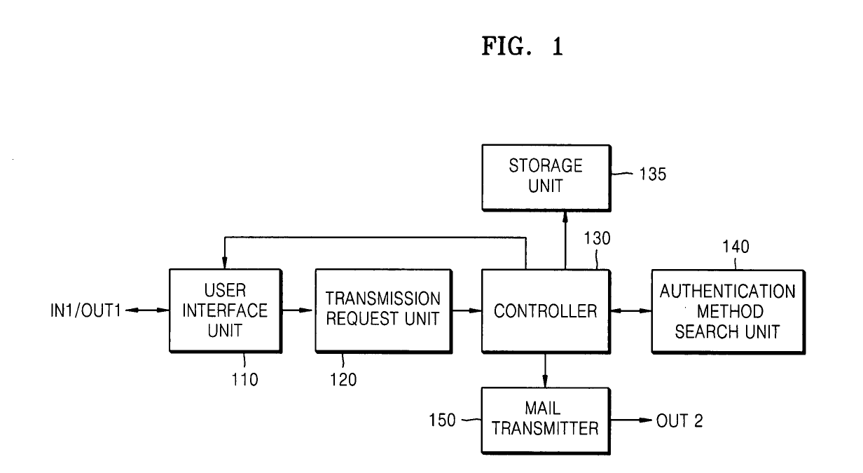

FIG. 1 is a block diagram of a mail server authentication apparatus according to an exemplary embodiment of the present invention. The mail server authentication apparatus includes a user interface unit 110, transmission request unit 120, controller 130, storage unit 135, authentication method search unit 140, and mail transmitter 150.

An e-mail can be made or created through various paths described below.

For example, an e-mail can be created by a user of a PC using a mail processing program in the PC. As described above, Microsoft Outlook Express is one example of a mail processing program.

The e-mail can also be created by the user using a peripheral information transfer program prepared in a host device. Various peripheral devices, such as a printer, scanner, copier, and MFP, can be connected to the host device.

In an exemplary implementation, the peripheral information transfer program can be implemented in a driver of a relevant peripheral device, which is prepared in the host device. When the peripheral information transfer program is used, an e-mail containing information on the state of the relevant peripheral device is created.

The e-mail also can be created in an SMTP device. The SMTP device is a device having an SMTP function, that is, a device which can generate data, and create and transmit an e-mail containing the data to a mail server.

A scan to e-mail device is an example of the SMTP device. The scan to e-mail device is an MFP having a scan function, that is, a device creating an e-mail containing scan data generated by scanning or received from a fax machine or another device, and transmitting the e-mail to a mail server.

Such an e-mail is provided to a mail client, and the mail client transmits the e-mail to a mail server. Hereinafter, the mail client and the mail server can be called an SMTP client and an SMTP server.

An authentication process can take place between the mail client and the mail server. In an exemplary implementation, the mail client can transmit an e-mail to the mail server if the mail server permits transmission of the e-mail.

That is, the mail client can transmit an e-mail to the mail server if the mail server determines, through authentication, that the e-mail can be transmitted. To obtain such authentication, authentication information is provided to the mail client.

For the mail client to transmit an e-mail to the mail server, the mail server determines that transmission of the e-mail is possible through authentication, as a result of examining the authentication information.

For example, such authentication information includes information regarding an authentication target and information on an authentication method. The information regarding an authentication target includes information regarding a target mail server and user identification information.

In an exemplary implementation, the target mail server is a mail server, which the mail client can connect to and to which the mail client intends to transmit an e-mail. The information regarding a target mail server is position information of the target mail server in a network. For example, the position information can be an Internet Protocol (IP) address or a fully qualified domain name (FQDN).

The user identification information is input by a user to the mail client in order to indicate that the mail client can be connected to the target mail server when the user uses the mail client. For example, a user's unique identification (ID) and password are an example of the user identification information.

Various authentication methods exist. A POP3BeforeSMTP method is an example of an authentication method. The POP3BeforeSMTP method is an authentication method by which a mail server grants a transmission right to a mail client, which can receive an e-mail from the mail server. The transmission right is a right that the mail client can transmit an e-mail to the mail server.

A non-authentication method, in which an authentication process is unnecessary, is another authentication method.

All units of the mail server authentication apparatus, as described above, are prepared in a mail client. OUT1 denotes a user interface through which authentication information is set, and IN1 denotes authentication information input through the user interface. The user interface unit 110 provides the user interface through which authentication information is set.

The transmission request unit 120 requests transmission of an e-mail provided with the authentication information to a mail server. Besides the authentication information input to the mail client, an edited and/or newly created e-mail, is also provided to the transmission request unit 120.

The controller 130 examines whether the mail server performs authentication according to the request using an authentication method contained in the provided authentication information, and receives the authentication result according to a control signal. The authentication method search unit 140 searches for an authentication method which can be performed by the mail server in response to the result examined by the controller 130 and outputs the search result as the control signal.

In more detail, the controller 130 examines whether the mail server performs authentication according to the request using an authentication method contained in the provided authentication information.

If a determination is made that the mail server performs authentication according to the request using the contained authentication method, the controller 130 demands the mail server to perform authentication of information on an authentication target included in the authentication information, which is provided with information on the contained authentication method.

If a determination is made that the mail server does not perform authentication according to the request using the indicated authentication method according to the request, the authentication method search unit 140 searches for an authentication method which can be performed by the mail server.

The authentication method search unit 140 informs the controller 130 of a determined authentication method, and displays the determined authentication method through the user interface unit 110. In an exemplary implementation, OUT1 denotes the determined authentication method.

Here, the user interface unit 110 can display various authentication methods, and the user can select one of the displayed authentication methods. The selected authentication method is provided to the transmission request unit 120.

The controller 130 re-examines whether the mail server performs authentication according to the request using the selected authentication method or the determined authentication method.

The storage unit 135 stores at least one of the provided authentication information and the determined authentication information. The stored authentication information can be displayed through the user interface unit 110 when the user wants to confirm the authentication information.

If the controller 130 re-recognizes that the mail server performs authentication according to the transmission request using the determined authentication method, the controller 130 demands the mail server to perform authentication of the information on the authentication target included in the authentication information, which is provided with information on the determined authentication method.

In an exemplary implementation, the mail server determines whether the mail client can transmit the e-mail by authenticating the authentication target using the determined authentication method. Here, the mail server can perform authentication of the user who has input the authentication target as the authentication information by determining whether the user can transmit the e-mail using the mail client.

The authentication result can determine whether transmission of the e-mail is possible or not possible. The authentication result is transmitted from the mail server to the controller 130 of the mail client.

That is, the mail server can transmit the authentication result to the mail client in a message format. The controller 130 can generate a signal using the transmitted authentication result.

The signal indicating the authentication result, generated by the controller 130, is called a transmission command signal. The transmitted authentication result can be displayed through the user interface unit 110.

For example, the user interface unit 110 can inform whether the transmission is possible. When the user interface unit 110 informs that the mail client cannot transmit the e-mail, the user interface unit 110 can inform whether the transmission failure was caused by the authentication target or the authentication method included in the provided authentication information.

If the mail transmission is impossible since the mail server cannot perform the authentication method contained in the provided authentication information, the authentication method search unit 140 can search again for an authentication method which can be performed by the mail server, and the user interface unit 110 can display the authentication method which is determined.

When the user interface unit 110 informs that the mail client can transmit the e-mail, the user interface unit 110 can inform of the authentication target and the authentication method included together in the provided authentication information.

If the mail server authenticates the user who has input the authentication target as the authentication information by determining that the user can transmit the e-mail using the mail client, the controller 130 commands the mail transmitter 150 to transmit the e-mail.

The mail transmitter 150 transmits the e-mail to the mail server according to the command. OUT2 denotes the e-mail transmitted to the mail server.

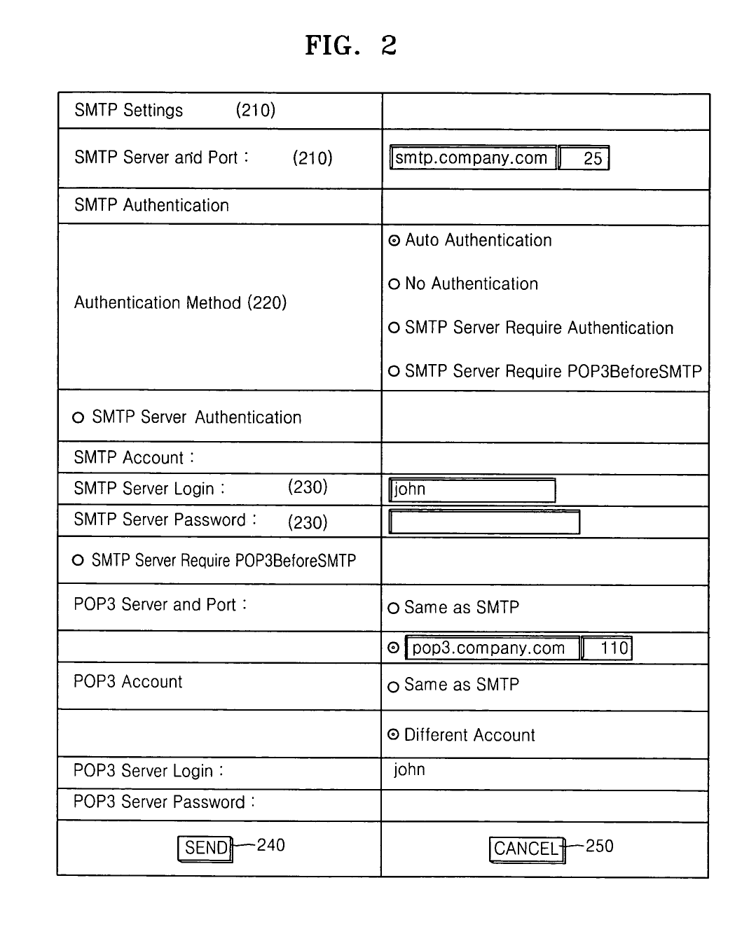

FIG. 2 is an example of contents displayed on the user interface unit 110 illustrated in FIG. 1. The user who intends to transmit an e-mail using the mail client can input authentication information having the contents illustrated in FIG. 2.

Referring to FIG. 2, the user intends to transmit e-mail to a mail server having an FQDN address, smtp.company.com. According to this example, an address 210 of the mail server can be an FQDN address or an IP address.

The user selects “Auto Authentication” as an authentication method 220 and inputs “john” as a log-in ID 230. The user also intends to receive e-mail through a mail client having an FQDN address, pop3.company.com.

The displayed authentication information includes information regarding the authentication targets 210 and 230, and information regarding the authentication method 220.

If the user clicks a send button 240, the transmission request unit 120 requests the controller 130 to command the mail transmitter 150 to operate.

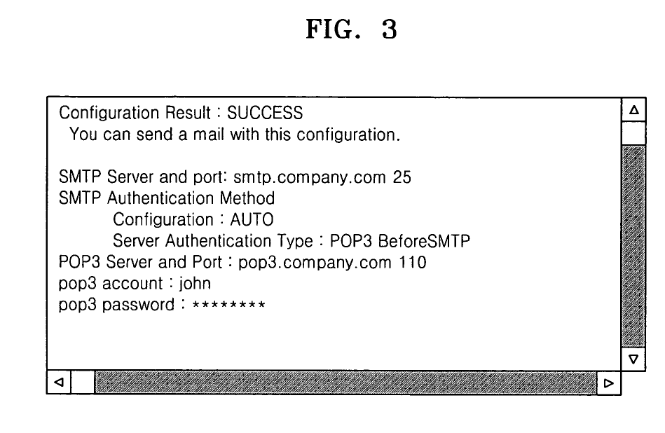

FIG. 3 is another example of contents displayed on the user interface unit 110 illustrated in FIG. 1. If a mail server determines, by authenticating the mail client, that a mail client can transmit e-mail, the mail server can transmit a message illustrated in FIG. 3 to the controller 130.

Referring to FIG. 3, at the time when the message is transmitted, the mail client is in a state of transmitting an e-mail to the mail server (Configuration Result: SUCCESS), the mail server to which the e-mail can be transmitted has an FQDN address of smtp.company.com, an authentication method which can be performed by the mail server is the POP3BeforeSMTP method determined by automatic search (AUTO). Since the mail client having an FQDN address of pop3.company.com can receive e-mail by inputting a unique ID “john” and a password “.”, the mail client can transmit an e-mail to the mail server.

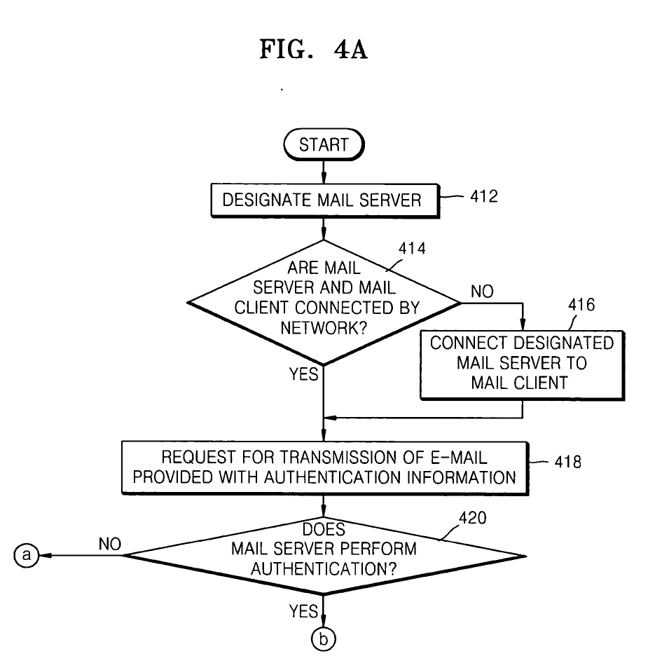

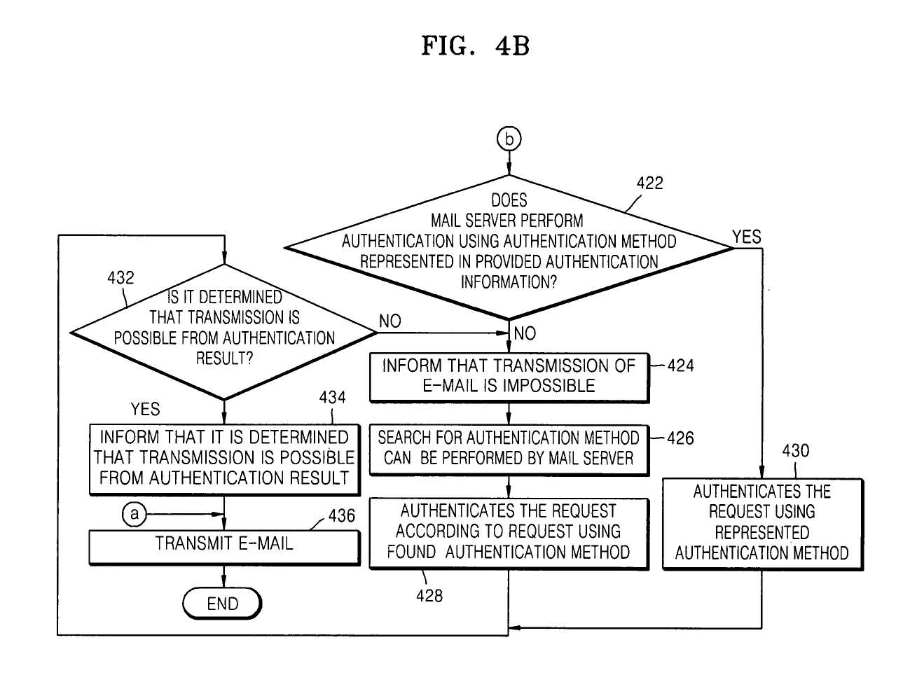

FIGS. 4A and 4B are flowcharts illustrating a mail server authentication method according to an exemplary embodiment of the present invention.

Referring to FIG. 4A, in operation 412, mail servers which can be connected to a mail client are displayed on the user interface unit 110, and a user designates one of the mail servers to receive an e-mail. Here, the designated mail server corresponds to the target mail server described above.

In operation 414, the controller 130 determines whether the target mail server is connected to the mail client. If a determination is made that the target mail server is not connected to the mail client, the controller 130 informs the user through the user interface unit 110.

In an exemplary implementation, the user knows through the user interface unit 110 that the target mail server is not connected to the mail client, and takes an action to connect the target mail server to the mail client in operation 416.

The user creates authentication information and an e-mail which are provided to the transmission request unit 120. In an exemplary implementation, in operation 418, the transmission request unit 120 requests the controller 130 to command the mail transmitter 150 to transmit the e-mail.

In operation 420, the controller 130 determines whether the target mail server requires authentication. For example, the controller 130 determines whether an authentication process should be taken to transmit the e-mail to the target mail server.

Referring to FIG. 4B, if a determination is made that the target mail server requires authentication, in operation 422, the controller determines whether the target mail server performs authentication according to the request using an authentication method contained in the provided authentication information.

If a determination is made that the target mail server does not perform authentication according to the request using the authentication method contained in the provided authentication information, in operation 424, the controller 130 informs the user through the user interface unit 110 that transmission of the e-mail is impossible.

In an exemplary implementation, in operation 426, the authentication method search unit 140 searches for an authentication method which can be performed by the target mail server, and the controller 130 demands the target mail server to perform authentication according to the request using the authentication method determined.

In operation 428, the target mail server performs authentication of the mail client by determining whether the mail client can transmit the e-mail to the target mail server in response to the demand, and transmits the authentication result to the controller 130.

The controller 130 generates a transmission command signal by referring to the transmitted authentication result. Accordingly, the transmission command signal can indicate whether the transmission is possible.

In operation 432, the controller 130 examines the authentication result and determines whether the target mail server has determined that the transmission is possible.

If a determination is made that the target mail server has determined that the transmission is possible, in operation 434, the controller 130 informs the user through the user interface unit 110. The contents illustrated in FIG. 3 are an example of contents informed in operation 434.

If a determination is made that the target mail server has determined that the transmission is impossible, the process proceeds to operation 424.

If a determination is made that the target mail server performs authentication according to the request using the authentication method contained in the provided authentication information in operation 422, the controller 130 demands the target mail server to perform authentication according to the request using the indicated authentication method.

In operation 430, the target mail server performs authentication by determining whether the mail client can transmit the e-mail to the target mail server in response to the demand, and transmits the authentication result to the controller 130, and then the process proceeds to operation 432.

If a determination is made that the transmission of the e-mail is possible in operation 432, or that the target mail server does not require authentication in operation 420, then in operation 436, the controller 130 commands the mail transmitter 150 to transmit the e-mail to the target mail server. The mail transmitter 150 then transmits the e-mail to the target mail server according to the command.

Certain exemplary embodiments of the present invention may be embodied in a general-purpose computer by running a program from a computer-readable medium, including but not limited to storage media such as magnetic storage media (ROMs, RAMs, floppy disks, magnetic tapes, and the like), optically readable media (CD-ROMs, DVDs, and the like), and carrier waves (transmission over the internet). Certain exemplary embodiments of the present invention may be embodied as a computer-readable medium having a computer-readable program code unit embodied therein for causing a number of computer systems connected via a network to effect distributed processing. The functional programs, code and code segments for embodying the present invention may be easily construed by programmers skilled in the art to which the present invention belongs.

As described above, according to exemplary embodiments of the present invention, in a mail server authentication method and apparatus, if a mail server does not perform authentication for determining whether transmission of an e-mail is possible or impossible using an authentication method contained in authentication information provided with the e-mail, then by automatically searching for an authentication method which can be performed by the mail server and performing authentication using the authentication method determined, a user who intends to transmit the e-mail does not have to know in advance whether the mail server performs authentication and what kind of authentication method is used, thereby increasing the user's convenience. Furthermore, when an e-mail cannot be transmitted because an authentication method, which can be performed by the mail server, is different from an authentication method input by the user, the user can be informed of an authentication method which the user should input. Thus, the user can know why transmission of the e-mail is impossible.

While the present invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A mail server authentication method, comprising:
requesting a transmission of an e-mail and authentication information;
determining whether a mail server authenticates the request using an authentication method represented in the authentication information;
if a determination is made that the mail server does not authenticate using the represented authentication method, searching for an authentication method performable by the mail server; and
receiving a result obtained by the mail server, which authenticates the request using the searched authentication method.

2. The method of claim 1, further comprising,
if a determination is made that the mail server does not authenticate using the represented authentication method, informing that the transmission cannot be performed.

3. The method of claim 1, further comprising:
determining, from the authentication, whether the transmission is possible; and
if determination is made that the transmission is possible, performing the transmission.

4. The method of claim 3, further comprising
informing as to whether the transmission is possible.

5. The method of claim 1, further comprising:
determining whether the mail server and a mail client are connected by a network; and
proceeding to the requesting of the transmission, if a determination is made that the mail server and the mail client are connected by the network.

6. The method of claim 1, further comprising:
searching again for an authentication method performable by the mail server; and
proceeding to at least one of the requesting of the transmission and the receiving of the result.

7. The method of claim 6, further comprising
informing of the searched again authentication method.

8. The method of claim 1, further comprising:
displaying the searched authentication method; and
generating authentication information representing the searched authentication method for replacing the provided authentication information and proceeding to the requesting of the transmission.

9. The method of claim 1, further comprising,
if a determination is made that the authentication is performed using the represented authentication method, receiving a result obtained by the mail server, which authenticates the request using the represented authentication method.

10. The method of claim 1, further comprising
storing at least one of the provided authentication information and the searched authentication information.

11. A mail server authentication apparatus controlling an e-mail to be transmitted to a mail server, the apparatus comprising:
a transmission request unit for requesting the transmission of an e-mail and authentication information;
a controller for examining whether the mail server authenticates the request using an authentication method represented in the authentication information and receiving an authentication result corresponding to a control signal; and
an authentication method search unit for searching for an authentication method performable by the mail server in response to an examination result and outputting a search result as the control signal.

12. The apparatus of claim 11, further comprising
a user interface unit for informing of an impossibility of at least one of the transmission of the request and the search result in response to the examination result.

13. The apparatus of claim 11, further comprising
a mail transmitter for performing the transmission corresponding to a transmission command signal,
wherein the controller examines, using the authentication information, whether the transmission is possible and outputs the examination result as the transmission command signal.

14. The apparatus of claim 13, further comprising
a user interface unit for informing whether the transmission can be performed corresponding to the transmission command signal.

15. The apparatus of claim 13, wherein the authentication method search unit searches again for an authentication method performable by the mail server corresponding to the transmission command signal.

16. The apparatus of claim 15, further comprising
a user interface unit for informing of the searched again authentication method.

17. A computer readable recording medium storing a computer readable program for performing a mail server authentication method, the method comprising:
requesting a transmission of an e-mail and authentication information;
determining whether a mail server authenticates the request using an authentication method represented in the authentication information;
if a determination is made that the mail server does not authenticate using the represented authentication method, searching for an authentication method performable by the mail server; and
receiving a result obtained by the mail server, which authenticates the request using the searched authentication method.

18. The method of claim 1, wherein a mail client controls transmission of the e-mail to the mail server.

19. The computer readable medium of claim 17, wherein the method is performed in a mail client controlling the e-mail to be transmitted to the mail server.
